(19) United States
(12) Patent Application Publication
(10) Pub. No.: US 2026/0319778 A1
(43) Pub. Date: Oct. 15, 2026

(54) CONTROLLING ARTIFACT IMAGE DEPLOYMENT USING DEPLOYMENT SYSTEM

(71) Applicant: Oracle International Corporation, Redwood Shores, CA (US)

(72) Inventor: Payal Godhani, Sammamish, WA (US)

(73) Assignee: Oracle International Corporation, Redwood Shores, CA (US)

(21) Appl. No.: 19/174,266

(22) Filed: Apr. 9, 2025

(51) Int. Cl. G06F 8/61

(52) U.S. Cl. CPC G06F 8/63

(57) ABSTRACT

A deployment system is disclosed that reduces or eliminates redundant deployments. For a particular artifact image to be deployed to a computing environment, the deployment system initiates the deployment only if (a) there has been no previous deployment of the particular artifact image to the computing environment, or (b) the version of the particular artifact image to be deployed is different from the previous version of the particular artifact image that was deployed to the computing environment and/or the computing environment has changed since that previous deployment. Different techniques are used to determine if the version of the particular artifact image to be deployed is same as or different from the previously deployed version of the particular artifact image, and also to determine if the computing environment has changed since that previous deployment.

### BACKGROUND

Modern software architectures and systems are typically very complex, as they rely on many interconnected components and services to implement the underlying infrastructure, applications, and services. As a result, deployment of such systems is also typically complex, uses significant compute resources, and uses a lot of time. The complexities in deployments arise from a variety of different components that can be included in the deployments, different target environments where the deployments can occur, and the timings when the deployments are to take place. For example, with the growing adoption of microservices and multi-region architectures, developers and service operators frequently execute multiple deployments daily. This can lead to several inefficiencies. For example, redundant deployments may be performed when there are no changes to the associated artifacts involved in the deployment and no changes to the target deployment environment. This behavior leads to wasted use of resources for the deployment (e.g., compute, memory, and networking resources), unnecessary downtime of the software system or application for which the deployment is being performed, and other inefficiencies.

### BRIEF SUMMARY

The present disclosure relates generally to deployment systems. More specifically, an improved deployment framework or system is disclosed that performs deployment efficiently by eliminating redundant deployments. The deployment system first determines if a deployment is needed based upon a particular artifact image to be deployed and based on the computing environment to which the image is to be deployed. With respect to particular artifact image, the deployment system determines whether the particular artifact image to be deployed has been previously deployed, and if it has been previously deployed, if the particular artifact image to be deployed is different from a version of the particular artifact image previously deployed. With respect to target computing environment for the deployment, the deployment system determines if the computing environment has changed since the previous deployment of the artifact image to that computing environment. In certain embodiments, the deployment system initiates a new deployment for the particular artifact image only if (a) there has been no previous deployment of the particular artifact image to the computing environment, or (b) the version of the particular artifact image is different from the previous version of the particular artifact image that was deployed to the computing environment and/or the computing environment has changed since that previous deployment.

In certain implementations, if the particular artifact image has been previously deployed to the computing environment, the deployment system does a comparison of the previously deployed version of the particular artifact image and the version of the particular artifact image to be deployed to identify any differences. In certain embodiments, the comparison is performed by comparing one or more checksums computed for the previous deployed version of particular artifact image and the version of particular artifact image to be deployed. For example, the deployment system can compare a first checksum of the particular artifact image to be deployed with a second checksum generated for a previously deployed version of the particular artifact image. If the first checksum and the second checksum are the same, this indicates that version of the particular artifact image to be deployed is the same as the previously deployed version of the particular artifact image. In such a case, the deployment system may proceed with the deployment only if the computing environment to which the deployment is to occur has changed since the previous deployment, else, the deployment may be identified as a redundant deployment and may not be performed. By using checksums, the deployment system is able to compare the versions of the particular artifact image quickly and in an efficient manner.

In certain embodiments, if the particular artifact image has been previously deployed to the computing environment and the previously deployed version of the particular artifact image is found to be the same as the version of the particular artifact image to be deployed, the deployment system additionally checks if the computing environment where the deployment is to occur has changed since the time of the previous deployment of the particular artifact image to that computing environment. The deployment system does this by comparing metadata associated with the computing environment at the time of the previous deployment with the current metadata associated with the computing environment. If the deployment system identifies a difference between the two metadata being compared, then it indicates that the computing environment has changed since the previous deployment. In this case, the deployment system initiates deployment of the current version of the particular artifact image even though there may be no difference between the current image being deployed and the previously deployed image. For example, the deployment system can compare first metadata from a current version or state of the computing environment with second metadata associated with the computing environment when the previous deployment of the particular artifact image was performed. If the first metadata and the second metadata are different, it indicates that the computing environment has changed since the previous deployment of the particular artifact image. In this case, the deployment system may proceed with the deployment even if the two versions of the particular artifact image are determined to be the same.

The computing environments where deployments are performed can be of different types. Examples include a compute instance, a container instance, a Kubernetes cluster, a function, and the like. The computing environment-related metadata that is used by the deployment system to determine whether the computing environment has changed since the previous deployment can be specific to the type of the computing environment. For example, the datapoints included in metadata for a compute instance can be different from the datapoints included in metadata for a container instance, which in turn may be different from the datapoints included in metadata for a Kubernetes cluster, and so on. Accordingly, when determining if the computing environment has changed since a previous deployment, the deployment system may first determine the type of the computing environment, then access the metadata based upon the determined type for the computing environment at the time of the previous deployment and at current time, and then do the comparison. The metadata that is compared is thus specific to the type of the computing environment.

Various embodiments are described herein to illustrate various features. These embodiments include various methods, systems, non-transitory computer-readable storage media storing programs, code, or instructions executable by one or more processors, and the like. Some embodiments may be implemented by using a computer program product, comprising computer program/instructions which, when executed by a processor (e.g., a CPU, a GPU), cause the processor to perform any of the methods described in the disclosure. The computer program and instructions may be stored on a non-transitory storage medium. The features disclosed in each embodiment can be combined in a relevant manner.

In certain embodiments, a method can include receiving a request to deploy an artifact image to a computing environment. The method can include accessing historical deployment data that includes information related to one or more deployments performed prior to the receiving. The method can include identifying, in the historical deployment data, an entry corresponding to a previous deployment of a version of the artifact image to the computing environment. The method can include determining, using the entry, whether the artifact image identified in the request is different from the version of the artifact image previously deployed. The method can include determining, using the entry, whether the computing environment identified in the request has changed since the previous deployment. The method can include deploying the artifact image to the computing environment only upon determining that at least one of (i) the artifact image is different from the version of the artifact image previously deployed, or (ii) the computing environment identified in the request has changed since the previous deployment.

In certain examples, identifying the entry can include (i) generating an image hash value based on a first identifier for the artifact image, (ii) generating an environment hash value based on a second identifier for the computing environment, and (iii) identifying the entry based on matching the image has value and the environment hash value with corresponding values in the entry.

In certain examples, the historical data can be stored in a cache.

In certain examples, determining whether the artifact image identified in the request is different from the version of the artifact image previously deployed can include (i) generating a current checksum for the artifact image to be deployed, (ii) determining, from the entry, a checksum generated for the version of the artifact image previously deployed, and (iii) comparing the current checksum to the checksum generated for the version of the artifact image previously deployed to determine whether the artifact image identified in the request is different from the version of the artifact image previously deployed.

In certain examples, determining whether the computing environment identified in the request has changed since the previous deployment can include (i) determining metadata for the computing environment at a time associated with the previous deployment, (ii) accessing current metadata for the computing environment, and (iii) comparing the current metadata with the metadata for the computing environment at the time associated with the previous deployment to determine whether the computing environment identified in the request has changed since the previous deployment.

In certain examples, comparing the current metadata with the metadata for the computing environment at the time associated with the previous deployment can include (i) determining a type of instance of the computing environment, (ii) determining a plurality of fields of metadata associated with the type of instance, and (iii) comparing the plurality of fields of the current metadata with the plurality of fields of the metadata for the computing environment at the time associated with the previous deployment to determine whether the computing environment identified in the request has changed since the previous deployment.

In certain examples, the computing environment can have a type of instance, and the type of instance can include one of a compute instance, a container instance, a Kubernetes cluster, or a function.

In certain examples, the compute instance can have a first set of metadata that includes (i) operating system updates and patches, (ii) CPU and memory resources, (iii) routing tables, (iv) security groups, (v) IP addressing, and (vi) firewall settings.

In certain examples, the container instance can have a second set of metadata that includes (i) container network interface, (ii) resource quotas, (iii) storage volumes, and (iv) namespace isolation.

In certain examples, the Kubernetes cluster can have a third set of metadata that includes (i) a Kubernetes cluster version and (ii) node resources.

In certain examples, the function can have a fourth set of metadata that includes (i) trigger configuration, (ii) memory limits, (iii) timeout settings, and (iv) virtual private cloud integration.

In certain examples, deploying the artifact image to the computing environment only upon determining that at least one of (i) the artifact image is different from the version of the artifact image previously deployed, or (ii) the computing environment identified in the request has changed since the previous deployment can additionally include not deploying the artifact image to the computing environment based on determining that (i) and (ii) are both false.

In certain examples, the method can additionally include presenting a user-selectable option via a graphical user interface, and receiving selection of the option can cause the artifact image to be deployed to the computing environment regardless of whether (i) and (ii) are false.

In certain examples, the entry can include a cache entry stored in a cache, and the entry can include an environment identification, a stage identification, an image identification, an image checksum, a type of environment, specifics of the environment, and a timestamp.

The foregoing, together with other features and embodiments will become more apparent upon referring to the following specification, claims, and accompanying drawings.

### BRIEF DESCRIPTION OF DRAWINGS

To easily identify the discussion of any particular element or act, the most significant digit or digits in a reference number refer to the figure number in which that element is first introduced.

FIG. 1 is a block diagram of a computing environment including a deployment system that can be used to control deployment of an artifact image to a computing environment, according to at least one embodiment.

FIG. 2 is a flowchart of a process to control deployment of an artifact image to a computing environment using a deployment system, according to at least one embodiment.

FIG. 3 is a flowchart of a process to determine whether differences between different versions of an artifact image or computing environment are present, according to at least one embodiment.

FIG. 4 is a flowchart of a process to use checksums to determine whether differences exist between artifact images, according to at least one embodiment.

FIG. 5 is a flowchart of a process to use metadata to determine whether differences exist between computing environments, according to at least one embodiment.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to deployment systems. More specifically, an improved deployment framework or system is disclosed that performs deployment efficiently by eliminating redundant deployments. The deployment system first determines if a deployment is needed based upon a particular artifact image to be deployed and based on the computing environment to which the image is to be deployed. With respect to particular artifact image, the deployment system determines whether the particular artifact image to be deployed has been previously deployed, and if it has been previously deployed, if the particular artifact image to be deployed is different from a version of the particular artifact image previously deployed. With respect to target computing environment for the deployment, the deployment system determines if the computing environment has changed since the previous deployment of the artifact image to that computing environment. In certain embodiments, the deployment system initiates a new deployment for the particular artifact image only if (a) there has been no previous deployment of the particular artifact image to the computing environment, or (b) the version of the particular artifact image is different from the previous version of the particular artifact image that was deployed to the computing environment and/or the computing environment has changed since that previous deployment.

In some embodiments, an artifact image can be or include a unit that can be deployed to a platform or any computing environment thereof. The platform can be or include a cloud computing platform, which can include one or more computing environments. Some examples of the artifact image can include a command specification, a Kubernetes.yaml file, a Helm chart, and the like. The artifact image may be scheduled or requested to be deployed to a single computing environment or to multiple computing environments in series or at least partially substantially contemporaneously. In some embodiments, a computing environment can be included in a cloud computing platform or other overall environment or platform that can be configured to include multiple computing environments. A computing environment can include a compute instance, a container instance, a Kubernetes cluster, a function, and/or any other suitable types of computing environments to which an artifact image can be deployed. In some embodiments, a deployment can include an execution of the artifact image on the computing environment. In some embodiments, the deployment system can be provided in cloud domain that can involve infrastructure provided by a cloud service provider. Additionally or alternatively, the platform may be or include a distributed computing environment for a set of all possible computing environments to which the particular artifact image can be deployed.

The deployment system can receive a request to perform a deployment, and the deployment system is configured to perform analysis based on the request. The request can include a particular artifact image to be deployed and an indication of a computing environment to which the particular artifact image is requested to be deployed. The deployment system is configured to analyze the particular artifact image and to analyze the computing environment to which the artifact image is to be deployed to determine whether the requested deployment is redundant. Additionally or alternatively, the deployment system is configured to control the deployment. For example, if the deployment system determines, based on the analysis performed on the particular artifact image and the computing environment, that the requested deployment is redundant, then the deployment system may cancel, prevent, or otherwise challenge the deployment for reducing computing resource consumption associated with the computing environment and/or the deployment system. Additionally or alternatively, if the deployment system determines, based on the analysis performed on the particular artifact image and the computing environment, that the requested deployment is likely not redundant, then the deployment system may perform the deployment.

The analysis performed by the deployment system can consume fewer computing resources and less time than other analyses performed by other systems. For example, the deployment system is configured to analyze the particular artifact image and the computing environment using one or more checksums, using one or more sets of metadata, etc. The deployment system can generate a first checksum for the particular artifact image and compare the first checksum to a second checksum for a previous version of the artifact image. The previous version of the artifact image may have previously been deployed to the computing environment, and the particular artifact image may be the same as, or changed from, the previous version of the artifact image. A result of the comparison between the first checksum and the second checksum can be used by the deployment system to determine whether the particular artifact image is changed from the previous version of the artifact image. In some examples, artifact images may be excessively large in terms of computer memory, and comparing entire versions of artifact images involves an excessive amount of computing resources and time. By using checksums to compare the particular artifact image with the previous version of the artifact image, the deployment system can determine whether the particular artifact image is different from the previous version of the artifact image using fewer computing resources, and in less time and with less latency, than other systems.

Additionally or alternatively, the deployment system is configured to use sets of metadata to determine whether the computing environment is changed from a previous deployment of the previous version of the artifact image. The deployment system can determine a type of computing environment, and based on the type of computing environment, the deployment system can determine particular metadata to gather and compare. The type of computing environment can include a compute instance, a container instance, a Kubernetes cluster, a function, and/or any other suitable types of computing environments, and each type of computing environment can have a unique set of metadata associated therewith. For example, a first set of metadata for a compute instance can include (i) operating system updates and patches, (ii) CPU and memory resources, (iii) routing tables, (iv) security groups, (v) IP addressing, and (vi) firewall settings. Additionally or alternatively, a second set of metadata for a container instance can include (i) container network interface, (ii) resource quotas, (iii) storage volumes, and (iv) namespace isolation.

Upon determining the set of metadata to gather and compare, the deployment system can gather the metadata for a comparison. For example, the deployment system can gather first metadata about the computing environment for a previous deployment of the previous version of the artifact image, and the deployment system can gather second metadata about the computing environment for the requested deployment. The deployment system is configured to compare the first metadata with the second metadata, and a result of the comparison can be used by the deployment system to determine whether the computing environment has changed since the previous deployment. In some examples, computing environments may be excessively large in terms of computer memory, and comparing entire versions of computing environments involves an excessive amount of computing resources and time. By using select sets of metadata to compare the computing environments, the deployment system can determine whether the computing environment has changed since the previous deployment using fewer computing resources, and in less time and with less latency, than other systems.

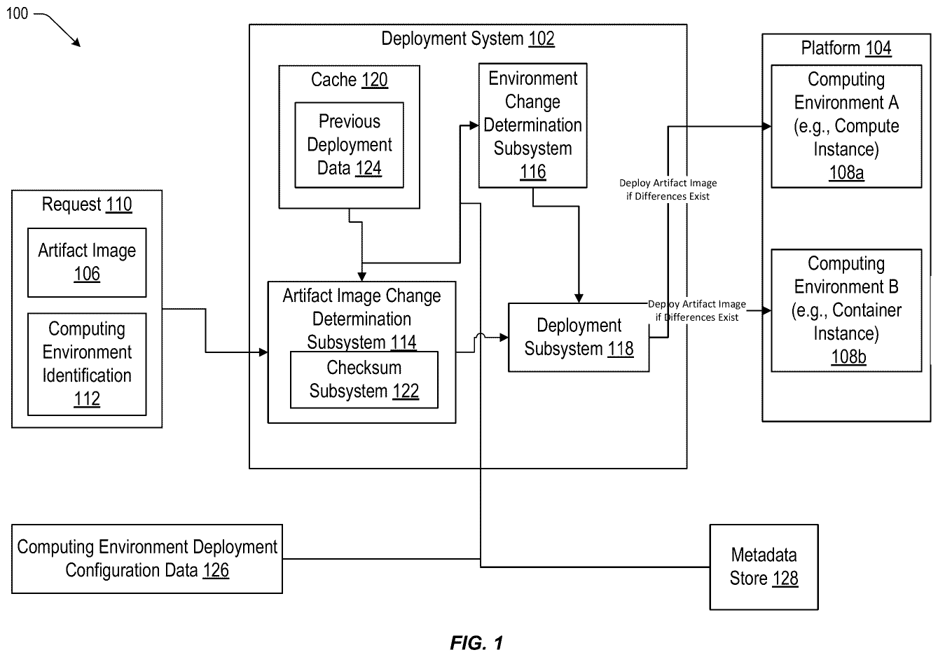

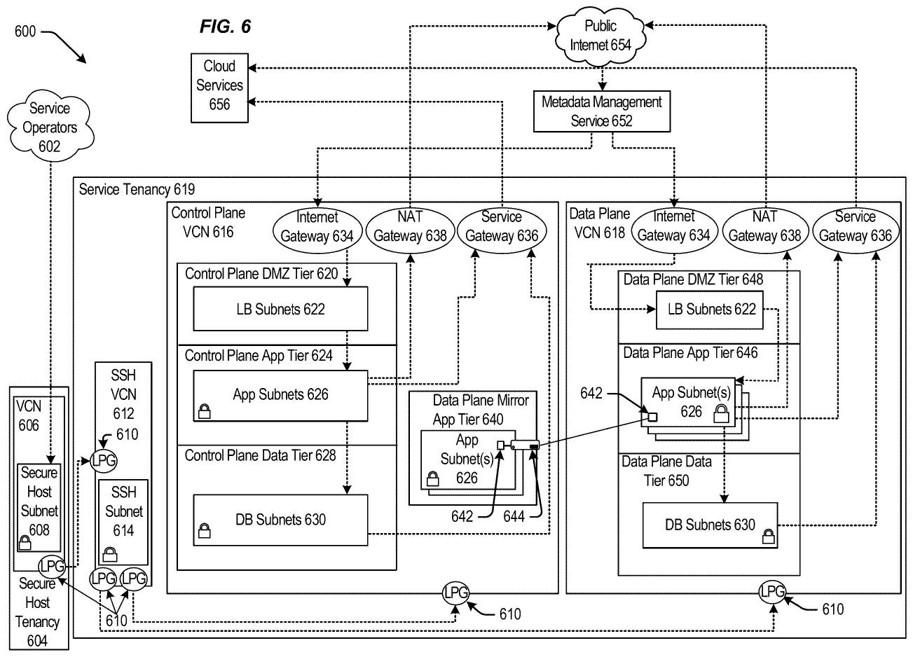

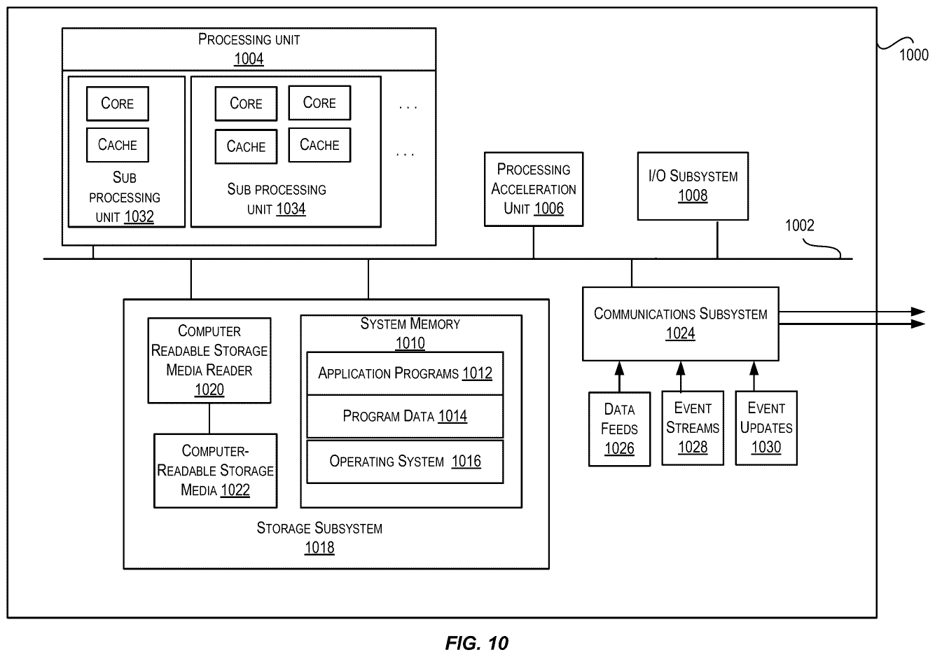

FIGS. 1-5 describe examples and embodiments related to a deployment system that can be used to control deployment of an artifact image to a computing environment based on differences associated with the artifact image and the computing environment. FIGS. 6-9 depict examples of architectures for implementing cloud infrastructures for providing one or more cloud services, where the infrastructures may incorporate teachings described herein. FIG. 10 depicts a block diagram illustrating an example computer system or device, according to at least one embodiment.

### Novel Deployment Techniques Using Deployment System

FIG. 1 is a block diagram of an overall computing environment 100 including a deployment system 102 that can be used to control deployment of an artifact image to a computing environment, according to at least one embodiment. As illustrated in FIG. 1, the overall computing environment 100 can include the deployment system 102 and a platform 104, though the overall computing environment 100 can include any additional, alternative, or fewer components to provide functionality for the overall computing environment 100. The platform 104 may include a cloud computing platform, or other suitable platform, that can include multiple computing environments to which an artifact image, such as artifact image 106, can be deployed by the deployment system 102. As illustrated in FIG. 1, the platform 104 includes computing environment A 108a and computing environment B 108b, though other suitable numbers, such as one or more than two, are possible. The deployment system 102 can be communicatively coupled with the platform 104, for example to allow the deployment system 102 to deploy the artifact image 106 to one or more computing environments included in the platform 104.

The deployment system 102 can receive a request 110. The request 110 may be generated by a user of the deployment system 102 or other suitable system that can be used to request a deployment of an artifact image to a computing environment on the platform. In some embodiments, the request 110 can include the artifact image 106, or an indication thereof, and the request 110 can include an identification 112 of the computing environment to which the artifact image 106 is requested to be deployed. The deployment system 102 can receive the request 110 and can parse the request 110 to determine (i) the artifact image 106 to be deployed and (ii) the computing environment to which to deploy the artifact image 106. In some embodiments, parsing the request 110 can involve the deployment system 102 using an indication of the artifact image 106 and the identification 112 of the computing environment to determine the artifact image 106 to deploy and the computing environment to which to deploy the artifact image 106.

As illustrated in FIG. 1, the deployment system 102 can include an artifact image change determination subsystem 114, an environment change determination subsystem 116, a deployment subsystem 118, and a cache 120, though the deployment system 102 can include any additional, alternative, or fewer subsystems to provide functionality for the deployment system 102. In some embodiments, one or more of the features of the deployment system 102 may be optional. For example, the deployment system 102 may not include the cache 120, and the cache 120 may be stored on a separate computing system that can be accessed by the deployment system 102. In some embodiments, the cache 120 can include one or more cache entries that have a certain structure or include certain types of data. For example, and as shown in the below Table 1, a cache entry in the cache 120 can include an environment ID, a stage ID, an artifact ID, an artifact checksum, a type of environment, environment specifics (e.g., environment metadata), and a timestamp. The environment ID, the stage ID, and the artifact ID may each be hashed values for identifying the computing environment, the stage of the deployment, and the artifact image, respectively.

TABLE 1

| | | | Artifact | Type of | Environment | |
|---|---|---|---|---|---|---|
| Environment ID | Stage ID | Artifact ID | Checksum | Environment | Specifics | Time |
| String (Max - | String (Max - | String (Max - | String (Max - | JSON_CLOB | JSON_CLOB | TIMESTAMP |
| 4000 bytes) | 4000 bytes) | 4000 bytes | 4000 bytes | (No Limit) | (No Limit) | |
| Hash Key 1 | Hash Key 2 | Hash Key 3 | | | | |

Additionally or alternatively, the environment specifics can be or include metadata about the particular computing environment. As shown in the below Table 2, different types of computing environments, shown on the left-hand column, can have different sets of metadata, shown on the right-hand column.

TABLE 2

| Environment | Env context to be Cached |
|---|---|
| Compute | OS Updates and Patches |
| Instance | CPU and Memory Resources |
| | Routing Tables |
| | Security Groups |
| | IP Addressing |
| | Firewall Settings |
| Container | Container Network Interface |
| Instance | Resource Quotas |
| | Storage Volumes |
| | Namespace Isolation |
| Kubernetes | Trigger Configuration |
| Cluster | Memory Limits |
| | Timeout Settings |
| | Virtual Private Cloud Integration |

In some embodiments, the artifact image change determination subsystem 114 can include a checksum subsystem 122, and the artifact image change determination subsystem 114 can be used by the deployment system 102 to determine whether the artifact image 106 is changed from a previous version of the artifact image 106. For example, the deployment system 102 can receive the request, can parse the request to identify the artifact image 106, and can perform processing on, or with respect to, the artifact image 106 to determine if the artifact image 106 is changed. The processing can include generating a checksum for the artifact image 106. In some embodiments, the artifact image change determination subsystem 114 can execute the checksum subsystem 122 to generate a first checksum based on the artifact image 106. The first checksum can include a SHA512 checksum or other suitable types of checksums or hashes. Additionally or alternatively, the artifact image change determination subsystem 114 can receive a second checksum for a previous version of the artifact image 106. In some embodiments, the artifact image change determination subsystem 114 can access the cache 120, or the deployment system 102 can access the cache 120, to access previous deployment data 124 about previous deployments involving previous versions of the artifact image 106. The previous deployment data 124 can include previous checksums generated for deployed versions of the artifact image 106, and the artifact image change determination subsystem 114 can identify, from the previous deployment data 124, a previous deployment of the previous version of the artifact image 106 and can receive the second checksum. The artifact image change determination subsystem 114 can use the first checksum and the second checksum to determine whether a change has been applied to the artifact image 106 since the previous deployment. For example, the artifact image change determination subsystem 114 can compare the first checksum with the second checksum to determine if they are exact matches, or fuzzy matches, of one another to determine if a change has occurred. A first result of the comparison performed by the artifact image change determination subsystem 114 can be provided to the deployment subsystem 118.

In some embodiments, the deployment system 102 can use the environment change determination subsystem 116 to determine whether a change has been made to a computing environment to which the artifact image 106 is requested to be deployed. For example, the deployment system 102 can determine, based on the identification 112 of the computing environment, that the artifact image 106 is requested to be deployed to computing environment A 108a, and the environment change determination subsystem 116 can compare different versions of computing environment A 108a. The environment change determination subsystem 116 can access, or otherwise receive data from, computing environment deployment configuration data 126, which can store data about computing environments involved in previous deployments. The environment change determination subsystem 116 can query the computing environment deployment configuration data 126 to request data about the computing environment to which the artifact image 106 is requested to be deployed. The environment change determination subsystem 116 can additionally access, or otherwise receive data from, a metadata store 128 that stores metadata about different deployment versions of computing environments involved in deployments. In some embodiments, the environment change determination subsystem 116 can determine a type of metadata to compare between versions of the computing environment based on a type of the computing environment. For example, the environment change determination subsystem 116 can determine the type of computing environment A 108a and can request or otherwise receive metadata associated with the type of computing environment determined for computing environment A 108a. The environment change determination subsystem 116 can receive first metadata for a current version of the computing environment and can receive second metadata for a previous version of the computing environment associated with a previous deployment of the artifact image 106. The environment change determination subsystem 116 can compare the first metadata with the second metadata, and a second result, based on the comparison, can be provided to the deployment subsystem 118.

The deployment subsystem 118 can receive the first result and the second result. That is, the deployment subsystem 118 can receive a determination from (i) the artifact image change determination subsystem 114 that indicates whether there is a change to the artifact image 106 based on compared checksums and (ii) the environment change determination subsystem 116 that indicates whether there is a change to the computing environment based on compared metadata. Additionally or alternatively, the deployment subsystem 118 can receive additional information, such as whether the artifact image 106 has previously been deployed to the computing environment, and can use the additional information, along with the first result and/or the second result to make decisions about deploying the artifact image 106. If the first result indicates that there is a change between the artifact image 106 and the previous version of the artifact image 106, or if the second result indicates that there is a change between the computing environment and a previous version of the computing environment, then the deployment subsystem 118 can cause the deployment to proceed and can deploy the artifact image 106 to the requested computing environment. If the first results indicates that there is not a change between the artifact image 106 and the previous version of the artifact image 106, and if the second result indicates that there is not a change between the computing environment and a previous version of the computing environment, then the deployment subsystem 118 can cause the deployment to not proceed and can cancel deployment of the artifact image 106 to the requested computing environment. In some embodiments, and in addition to canceling the deployment, the deployment subsystem 118 can provide a user-selectable option for overriding the cancelation of the deployment to proceed with a redundant deployment.

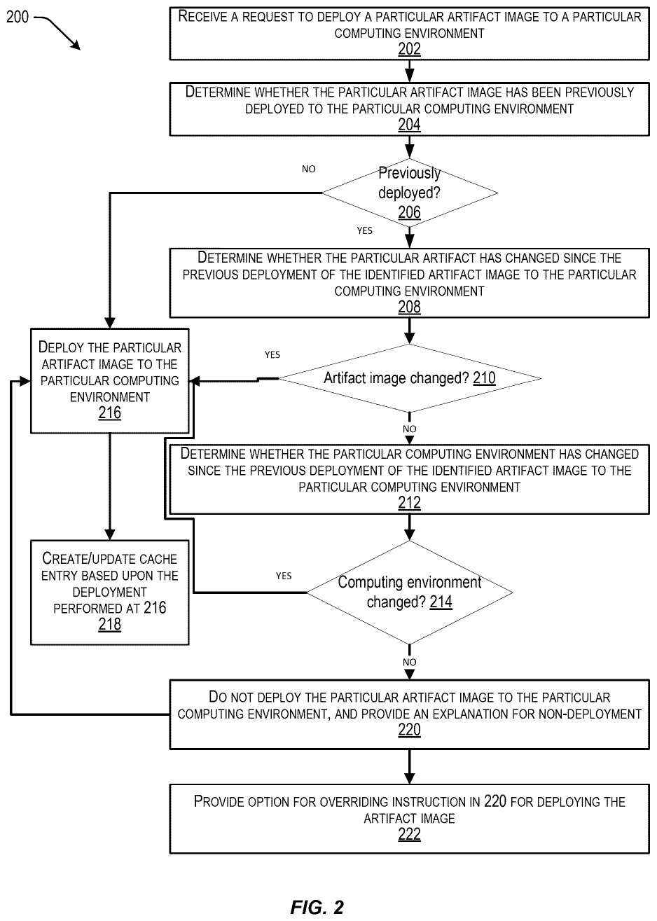

FIG. 2 is a flowchart of a process 200 to control deployment of an artifact image to a computing environment using a deployment system, according to at least one embodiment. The processing depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the processing may be performed in some different order or some steps may also be performed in parallel. It should be appreciated that in alternative embodiments, the processing depicted in FIG. 2 may include a greater number or a lesser number of steps than those depicted in FIG. 2. In certain embodiments, such as in the embodiment depicted in FIG. 1, the processing depicted in FIG. 2 may be performed by the deployment system 102 or any subset thereof.

At 202, the process 200 involves receiving a request to deploy a particular artifact image to a particular computing environment. For example, the deployment system 102 can receive the request 110 from a user of the deployment system 102, and the deployment system 102 can determine the particular artifact image and the particular computing environment. The request 110 can include an indication, or an identification, of the particular artifact image, and the request 110 can include an indication, or an identification, of the particular computing environment. The deployment system 102 can use the first indication and the second indication to identify the particular artifact image to be deployed and to identify the particular computing environment to which the particular artifact image is to be deployed. In some embodiments, the indications included in the request 110 can include an identification of where the particular artifact image is stored, on what platform the particular computing environment is located, etc. For example, the particular computing environment can be located or otherwise stored on a cloud computing platform that can include a set of one or more computing environments. Additionally or alternatively, the particular artifact image can be or include a unit that can be deployed to the platform or any computing environment thereof such as the particular computing environment. Some examples of the particular artifact image can include a command specification, a Kubernetes.yaml file, a Helm chart, and the like. Additionally or alternatively, the particular computing environment can be included in the cloud computing platform or other overall environment or platform that can be configured to include multiple computing environments. The particular computing environment can include a compute instance, a container instance, a Kubernetes cluster, a function, and/or any other suitable types of computing environments to which an artifact image can be deployed. In some embodiments, deploying the particular artifact image can include an execution of the particular artifact image on the particular computing environment.

At 204, the process 200 involves determining whether the particular artifact image has been previously deployed to the particular computing environment. The deployment system 102 can access historical, or previous, deployment data associated with the particular artifact image and/or the particular computing environment. For example, the deployment system 102 can access the cache 120 to retrieve the previous deployment data 124. The deployment system 102 can parse the previous deployment data 124 to determine whether the particular artifact image has previously been deployed to the particular computing environment. In some embodiments, the deployment system 102 may search for cache entries in the cache 120, or from the previous deployment data 124, that include data matching identifications or indications for the particular artifact image and/or the particular computing environment.

At 206, the process 200 involves the deployment system 102 making a decision about whether the particular artifact image has previously been deployed to the particular computing environment. In some embodiments, the deployment system 102 can determine whether a current version of the particular artifact image has previously been deployed to a current version of the particular computing environment. If the deployment system 102 determines that the particular artifact image has previously been deployed to the particular computing environment, the process 200 may proceed to 208. If the deployment system 102 determines that the particular artifact image has not previously been deployed to the particular computing environment, the process 200 may proceed to 216.

At 208, the process 200 involves determining whether the particular artifact image has changed since the previous deployment of the identified artifact image to the particular computing environment. For example, and in response to determining that the particular artifact image has previously been deployed to the particular computing environment, the deployment system 102 can compare a current version of the particular artifact image to a previous version of the particular artifact image. The deployment system 102 can access a cache entry that includes data relating to a previous deployment of the particular artifact image to the particular computing environment, and the deployment system 102 can extract a checksum, such as a second checksum, associated with the previous version of the particular artifact image. Additionally or alternatively, the deployment system 102 can generate a first checksum by hashing the particular artifact image. In some embodiments, the first checksum, the second checksum, or a combination thereof can be or include a SHA512 checksum or other suitable checksum or hash. The deployment system 102 can compare the first checksum with the second checksum to determine whether the first checksum matches the second checksum. In some embodiments, the deployment system 102 may determine whether the first checksum is an exact match with, or otherwise identical to, the second checksum. Additionally or alternatively, the deployment system 102 may determine whether the first checksum is a fuzzy match with, or is otherwise above a similarity threshold with respect to, the second checksum. Based on the comparison, the deployment system 102 can generate an output that indicates whether the current version of the particular artifact image has previously been deployed to the particular computing environment. In other words, based on the comparison using the first checksum and the second checksum, the deployment system 102 can determine whether the particular artifact image previously deployed to the particular computing environment has changed since the previous deployment.

At 210, the process 200 involves the deployment system 102 making a decision about whether the particular artifact image has changed since the previous deployment to the particular computing environment. In some embodiments, the deployment system 102 can make the decision based on the result from the comparison described with respect to 208. If the deployment system 102 determines that the particular artifact image has not changed since the previous deployment to the particular computing environment, the process 200 may proceed to 212. If the deployment system 102 determines that the particular artifact image has changed since the previous deployment to the particular computing environment, the process 200 may proceed to 216.

At 212, the process 200 involves determining whether the particular computing environment has changed since the previous deployment of the identified artifact image to the particular computing environment. For example, and in response to (i) determining that the particular artifact image has previously been deployed to the particular computing environment and (ii) determining that the particular artifact image has not changed since the previous deployment, the deployment system 102 can compare a current version of the particular computing environment to a previous version of the particular computing environment. The deployment system 102 can access a cache entry that includes data relating to a previous deployment of the particular artifact image to the particular computing environment, and the deployment system 102 can extract metadata, such as second metadata, associated with the previous version of the particular computing environment. Additionally or alternatively, the deployment system 102 can extract first metadata associated with the current version of the particular computing environment. In some embodiments, the deployment system 102 can determine what type of metadata to extract based on a type of the particular computing environment. For example, the deployment system 102 can extract first types of metadata for a compute instance, can extract second types of metadata for a container instance, and so on for other types of computing environments. The deployment system 102 can compare the first metadata with the second metadata to determine whether the first metadata matches the second metadata. In some embodiments, comparing the first metadata with the second metadata can involve comparing data included in a first set of fields of the first metadata with data included in a second set of fields of the second metadata.

In some embodiments, the deployment system 102 may determine whether the first metadata is an exact match with, or otherwise identical to, the second metadata. Additionally or alternatively, the deployment system 102 may determine whether the first metadata is a fuzzy match with, or is otherwise above a similarity threshold with respect to, the second metadata. Based on the comparison, the deployment system 102 can generate an output that indicates whether the current version of the particular computing environment includes a change from a previous version of the particular computing environment associated with the previous deployment of the particular artifact image to the particular computing environment. In other words, based on the comparison using the first metadata and the second metadata, the deployment system 102 can determine whether the particular computing environment to which the previous version of the particular artifact image was previously deployed has changed since the previous deployment.

At 214, the process 200 involves the deployment system 102 making a decision about whether the particular computing environment has changed since the previous deployment of the particular artifact image to the particular computing environment. In some embodiments, the deployment system 102 can make the decision based on the result from the comparison described with respect to 212. If the deployment system 102 determines that the particular computing environment has changed since the previous deployment of the particular artifact image to the particular computing environment, the process 200 may proceed to 216. If the deployment system 102 determines that the particular computing environment has not changed since the previous deployment of the particular artifact image to the particular computing environment, the process 200 may proceed to 220.

At 216, the process 200 involves deploying the particular artifact image to the particular computing environment. In response to the deployment system 102 determining that (i) the particular artifact image has not been deployed to the particular computing environment, (ii) the particular artifact image has changed since a previous deployment of the particular artifact image to the particular computing environment, or (iii) the particular computing environment has changed since a previous deployment of the particular artifact image to the particular computing environment, the deployment system 102 can deploy the particular artifact image to the particular computing environment. As an example, the deployment subsystem 118 can establish a communication channel between the deployment system 102 and the particular computing environment, and the deployment subsystem 118 can execute, or can cause execution of, the particular artifact image on the particular computing environment.

At 218, the process 200 involves creating and/or updating a cache entry based upon the deployment performed at 216. The cache 120 may include a cache entry associated with the particular artifact image and the particular computing environment. In these examples, the deployment system 102 can access the cache entry and can update the cache entry to reflect the deployment performed at 216. That is, the deployment system 102 can update metadata or other data included in the cache entry to be current based on the deployment performed at 216. In examples in which no cache entry exists for the particular artifact image associated with the particular computing environment, the deployment system 102 can create a new cache entry to be stored on the cache 120, and the new cache entry can include data and metadata reflecting, or otherwise based on, the deployment performed at 216.

At 220, the process 200 involves not deploying the particular artifact image to the particular computing environment and providing an explanation for non-deployment. In some embodiments, the deployment system 102 can cancel, in response to determining that (i) the particular artifact image has been deployed to the particular computing environment, (ii) the particular artifact image has not changed since a previous deployment of the particular artifact image to the particular computing environment, and (iii) the particular computing environment has not changed since a previous deployment of the particular artifact image to the particular computing environment, cancel deployment of the particular artifact image to the particular computing environment. Canceling the deployment can involve transmitting a notification to the user that generated and/or submitted the request 110 to inform the user that the deployment has been canceled due to the deployment likely being redundant. In some embodiments, the deployment system 102 may cease operations with respect to the request 110 after 220. In other embodiments, the process 200 may proceed to 222.

At 222, the process 200 involves providing an option for overriding the instruction generated in 220. That is, the deployment system 102 can provide a user-selectable option, such as via the notification transmitted to the user, that, when selected, overrides the cancelation of the deployment. Overriding the cancelation of the deployment may result in the deployment system 102 proceeding with the deployment of the particular artifact image to the particular computing environment despite the deployment potentially being redundant with respect to a previously executed deployment.

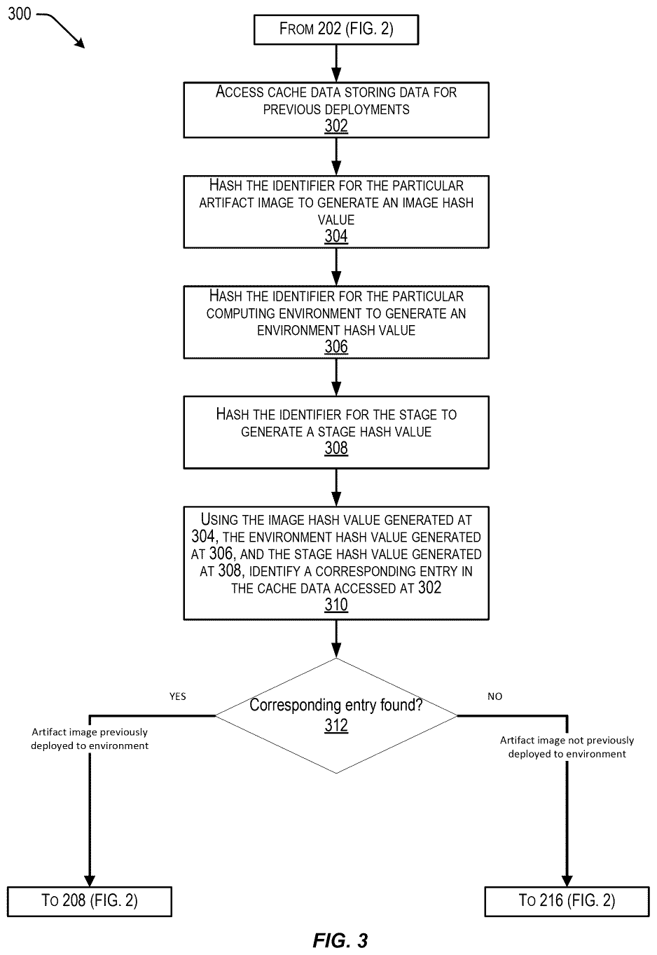

FIG. 3 is a flowchart of a process 300 to determine whether differences between different versions of an artifact image or computing environment are present, according to at least one embodiment. The processing depicted in FIG. 3 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order or some steps may also be performed in parallel. It should be appreciated that in alternative embodiments, the processing depicted in FIG. 3 may include a greater number or a lesser number of steps than those depicted in FIG. 3. In certain embodiments, such as in the embodiment depicted in FIG. 1, the processing depicted in FIG. 3 may be performed by the deployment system 102 or any subset thereof.

At 302, the process 300 involves accessing cache data storing data for previous deployments. The cache data may be stored at the cache 120 and may be accessed by the deployment system 102. In some embodiments, the cache data accessed by the deployment system 102 can include the previous deployment data 124. Additionally or alternatively, the deployment system 102 may access the cache data after receiving the request, which may be received at 202 in the process 200, to deploy the particular artifact image to the particular computing environment.

At 304, the process 300 involves hashing an identifier for the particular artifact image to generate an image hash value. The identifier for the particular artifact image can be included in the request and/or can be included in the cache data. In some embodiments, the identifier can be used to generate a checksum that is an image hash value, though other suitable identifiers and/or image hash values can be generated by the deployment system 102 for the particular artifact image. In some embodiments, the image hash value may correspond with a second image hash value included in the cache data.

At 306, the process 300 involves hashing an identifier for the particular computing environment to generate an environment hash value. The identifier for the particular computing environment can be included in the request and/or can be included in the cache data. In some embodiments, the identifier can be used to extract metadata about the particular computing environment. In some embodiments, the environment hash value may correspond with a second environment hash value included in the cache data.

At 308, the process 300 involves hashing an identifier for a particular stage associated with the deployment to generate a stage hash value. In some embodiments, the stage of the deployment can indicate how mature the deployment or the particular computing environment is with respect to an overall deployment plan. The identifier for the particular stage can be included in the request and/or can be included in the cache data. In some embodiments, the identifier can be used to tie the deployment of the particular artifact image to the particular computing environment to a stage associated with the deployment. In some embodiments, the stage hash value may correspond with a second stage hash value included in the cache data.

At 310, the process 300 involves using the image hash value generated at 304, the environment hash value generated at 306, and the stage hash value generated at 308 to identify a corresponding entry in the cache data accessed at 302. For example, the deployment system 102 can compare the image hash value generated at 304, the environment hash value generated at 306, and the stage hash value generated at 308 to different entries in the cache 120 to determine if any entry in the cache 120 has a match with respect to the different hash values. The match may be or include an exact match or a fuzzy match.

At 312, the process 300 involves the deployment system 102 making a decision about whether the a corresponding entry in the cache 120 has matches with the hashed values determined at 304, 306, and 308. In some embodiments, the deployment system 102 can make the decision based on a result from a comparison between the hashed values determined at 304, 306, and 308 and hashed values included in each cache entry included in the cache 120. If the deployment system 102 determines that a particular cache entry corresponds with the hashed values determined at 304, 306, and 308, the deployment system 102 can determine that the particular artifact image has previously been deployed to the particular computing environment, and the process 300 may proceed to 208 in the process 200. If the deployment system 102 determines that no cache entries correspond with the hashed values determined at 304, 306, and 308, the deployment system 102 can determine that the particular artifact image has not previously been deployed to the particular computing environment, and the process 300 may proceed to 216 in the process 200.

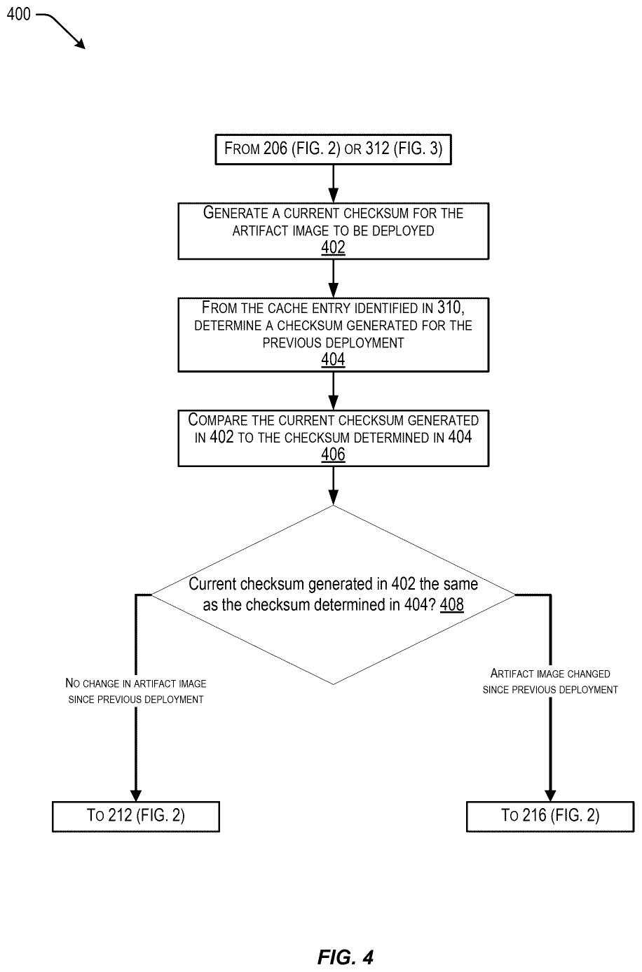

FIG. 4 is a flowchart of a process 400 to use checksums to determine whether differences exist between artifact images, according to at least one embodiment. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order or some steps may also be performed in parallel. It should be appreciated that in alternative embodiments, the processing depicted in FIG. 4 may include a greater number or a lesser number of steps than those depicted in FIG. 4. In certain embodiments, such as in the embodiment depicted in FIG. 1, the processing depicted in FIG. 4 may be performed by the deployment system 102 or any subset thereof.

At 402, the process 400 involves generating a current checksum for the particular artifact image to be deployed to the particular computing environment. The deployment system 102, or any subsystem thereof, such as the artifact image change determination subsystem 114, can receive or access the particular artifact image and can generate a current checksum for the particular artifact image. In some embodiments, generating the current checksum can involve generating a SHA512 checksum based on the particular artifact image. The SHA512 checksum may be representative of the particular artifact image. For example, the SHA512 checksum can indicate the particular artifact image without needing to store each and every detail or data point about the particular artifact image. Additionally or alternatively, the current checksum can be generated, such as by the checksum subsystem 122, by querying an artifact service on which the particular artifact image is stored or by otherwise calculating the current checksum.

At 404, the process 400 involves, from the cache entry identified in 310 of the process 300, determining a second checksum generated for the previous deployment of the particular artifact image to the particular computing environment. The deployment system 102, or any subsystem thereof, can access the cache entry identified in 310, and the deployment system 102 can extract the second checksum from the cache entry identified in 310. In some embodiments, the second checksum may have previously been generated and/or used based on a previous version of the particular artifact image associated with the previous deployment. The second checksum may have been generated based on the SHA512 algorithm or may have otherwise been generated using similar or identical techniques as those used to generate the current checksum for the particular artifact image.

At 406, the process 400 involves comparing the current checksum generated in 402 to the second checksum determined in 404. The deployment system 102, or any subsystem thereof, can compare the current checksum generated in 402 to the second checksum determined in 404 to determine whether the current checksum generated in 402 matches the second checksum determined in 404. A match may involve an exact match in which the current checksum generated in 402 and the second checksum determined in 404 are identical. Additionally or alternatively, the match may involve a fuzzy match in which the current checksum generated in 402 is above a similarity threshold with respect to the second checksum determined in 404. That is, the deployment system 102 can determine that the current checksum generated in 402 matches the second checksum determined in 404 if they are similar enough with respect to one another.

At 408, the process 400 involves the deployment system 102 making a decision about whether the current checksum generated in 402 matches, or is otherwise the same as, the second checksum determined in 404. In some embodiments, the deployment system 102 can make the decision based on a result from a comparison, such as the comparison performed at 406, between the current checksum generated in 402 and the second checksum determined in 404. If the deployment system 102 determines that the current checksum generated in 402 matches the second checksum determined in 404, the deployment system 102 can determine that the particular artifact image has not changed since a previous deployment of the particular artifact image to the particular computing environment, and the process 400 may proceed to 212 in the process 200. If the deployment system 102 determines that the current checksum generated in 402 does not match the second checksum determined in 404, the deployment system 102 can determine that the particular artifact image has changed since a previous deployment of the particular artifact image to the particular computing environment, and the process 400 may proceed to 216 in the process 200.

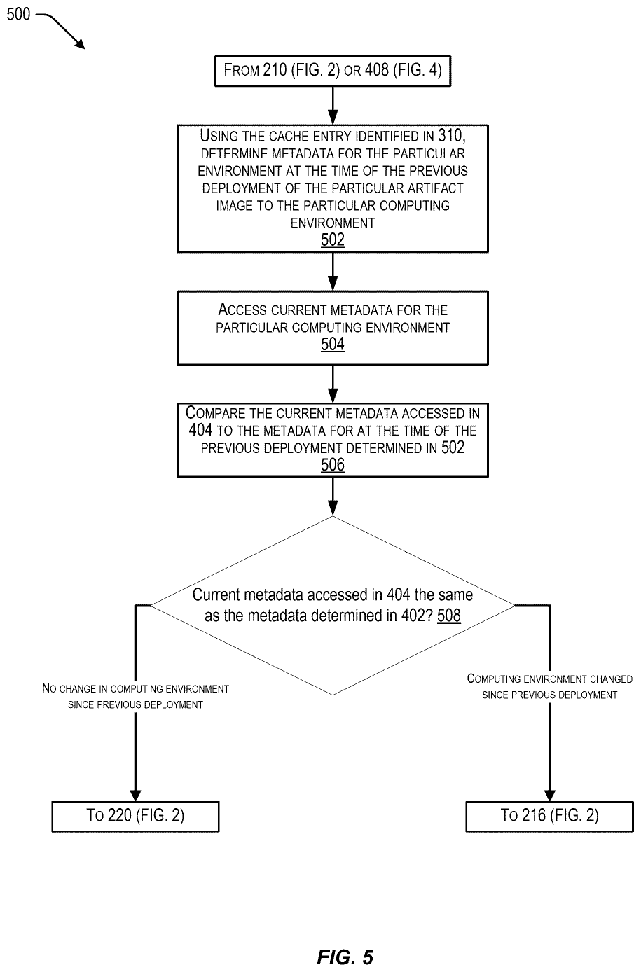

FIG. 5 is a flowchart of a process 500 to use metadata to determine whether differences exist between computing environments, according to at least one embodiment. The processing depicted in FIG. 5 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain alternative embodiments, the processing may be performed in some different order or some steps may also be performed in parallel. It should be appreciated that in alternative embodiments, the processing depicted in FIG. 5 may include a greater number or a lesser number of steps than those depicted in FIG. 5. In certain embodiments, such as in the embodiment depicted in FIG. 1, the processing depicted in FIG. 5 may be performed by the deployment system 102 or any subset thereof.

At 502, the process 500 involves, using the cache entry identified in 310 of the process 300, determining second metadata for the particular computing environment at the time of the previous deployment of the particular artifact image to the particular computing environment. The deployment system 102, or any subset thereof, can access the cache entry and can determine a type of the particular computing environment. Some examples of types of computing environments can include a compute instance, a container instance, a Kubernetes cluster, a function, and/or any other suitable type of computing environment. In some embodiments, each type of computing environment can include a different set of metadata that can include a different set of fields that can be compared. For example, the compute instance can have a first set of metadata that includes (i) operating system updates and patches, (ii) CPU and memory resources, (iii) routing tables, (iv) security groups, (v) IP addressing, and (vi) firewall settings. Additionally or alternatively, the container instance can have a second set of metadata that includes (i) container network interface, (ii) resource quotas, (iii) storage volumes, and (iv) namespace isolation. Additionally or alternatively, the Kubernetes cluster can have a third set of metadata that includes (i) a Kubernetes cluster version and (ii) node resources. Additionally or alternatively, the function can have a fourth set of metadata that includes (i) trigger configuration, (ii) memory limits, (iii) timeout settings, and (iv) virtual private cloud integration. Any other suitable sets of metadata or types of computing environments are possible. The deployment system 102 can identify the type of computing environment for the particular computing environment at the time of the previous deployment of the particular artifact image to the particular computing environment, and the deployment system 102 can determine a particular set of metadata to extract for comparison. The deployment system 102 can extract the particular set of metadata as the second metadata about the particular computing environment at the time of the previous deployment of the particular artifact image to the particular computing environment.

At 504, the process 500 involves accessing current metadata for the particular computing environment to which the particular artifact image is requested to be deployed in the request 110. The deployment system 102 can verify that the particular computing environment to which the particular artifact image is requested to be deployed has the same, or similar, type of computing environment as the particular computing environment at the time of the previous deployment of the particular artifact image to the particular computing environment. The deployment system 102 can extract the current metadata, and the current metadata can include the same or similar fields as the second metadata determined at 502.

At 506, the process 500 involves comparing the current metadata accessed in 504 to the second metadata at the time of the previous deployment determined in 502. The deployment system 102, or any subsystem thereof, can compare the current metadata accessed in 504 to the second metadata at the time of the previous deployment determined in 502 to determine whether the second metadata generated in 502 matches the current metadata determined in 504. A match may involve an exact match in which the second metadata generated in 502 and the current metadata determined in 504 are identical. Additionally or alternatively, the match may involve a fuzzy match in which the second metadata generated in 502 is above a similarity threshold with respect to the current metadata determined in 504. That is, the deployment system 102 can determine that the second metadata generated in 502 matches the current metadata determined in 504 if they are similar enough with respect to one another.

At 508, the process 500 involves the deployment system 102 making a decision about whether the second metadata generated in 502 matches, or is otherwise the same as, the current metadata determined in 504. In some embodiments, the deployment system 102 can make the decision based on a result from a comparison, such as the comparison performed at 506, between the second metadata generated in 502 and the current metadata determined in 504. If the deployment system 102 determines that the second metadata generated in 502 matches the current metadata determined in 504, the deployment system 102 can determine that the particular computing environment has not changed since a previous deployment of the particular artifact image to the particular computing environment, and the process 500 may proceed to 220 in the process 200. If the deployment system 102 determines that the second metadata generated in 502 does not match the current metadata determined in 504, the deployment system 102 can determine that the particular computing environment has changed since a previous deployment of the particular artifact image to the particular computing environment, and the process 500 may proceed to 216 in the process 200.

### Examples of Architectures for Implementing Cloud Services

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may need to be set up first. In some instances, the provisioning can be done manually, a provisioning tool may be utilized to provision the resources, and/or deployment tools may be utilized to deploy the code once the infrastructure is provisioned.

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

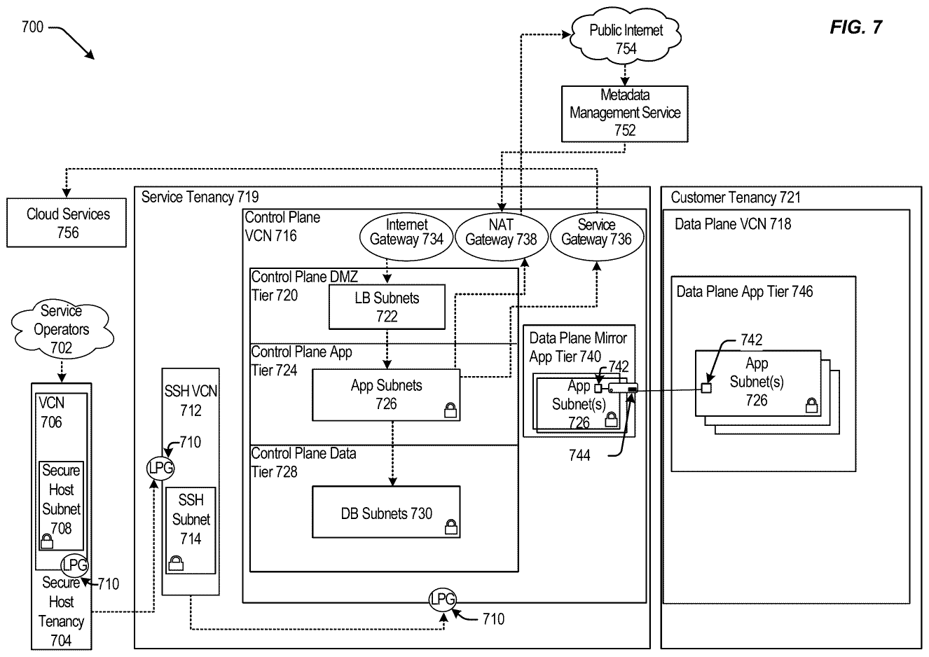

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively coupled to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 5,” may be located in Region 1 and in “Region 2.” If a call to Deployment 5 is made by the service gateway 736 contained in the control plane VCN 716 located in Region 1, the call may be transmitted to Deployment 5 in Region 1. In this example, the control plane VCN 716, or Deployment 5 in Region 1, may not be communicatively coupled to, or otherwise in communication with, Deployment 5 in Region 2.

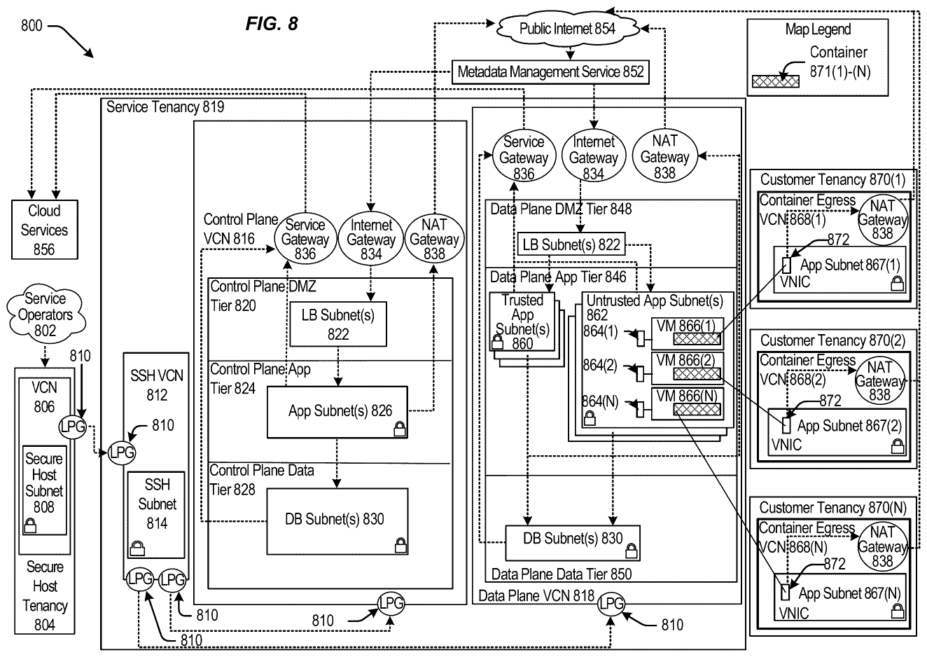

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

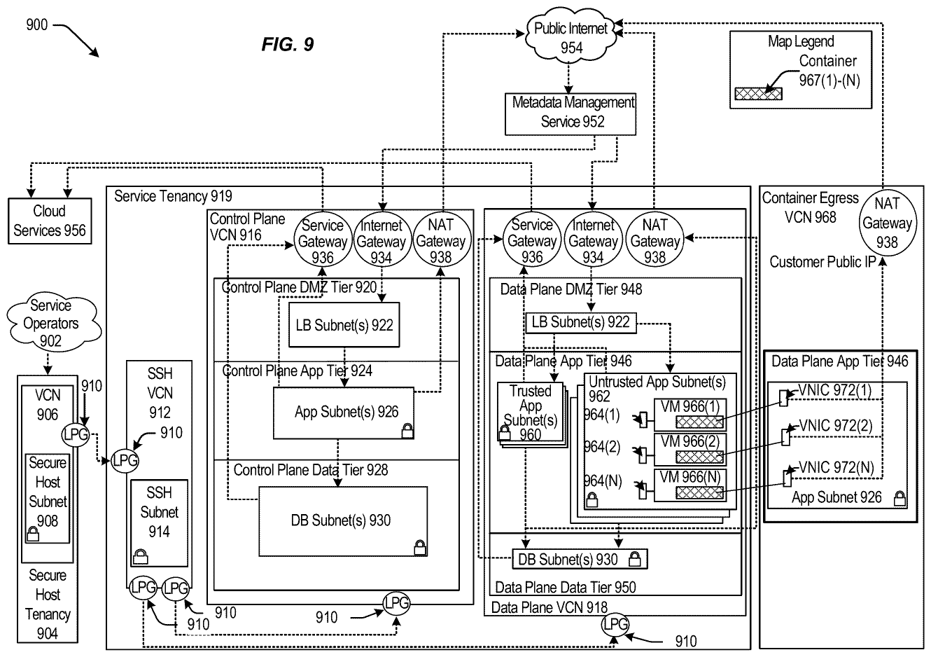

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

### Example of a Computer System or Device

FIG. 10 illustrates an example computer system 1000 that may be used to implement various embodiments described in this disclosure. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, the method comprising:
receiving a request to deploy an artifact image to a computing environment;
accessing historical deployment data comprising information related to one or more deployments performed prior to the receiving;
identifying, in the historical deployment data, an entry corresponding to a previous deployment of a version of the artifact image to the computing environment;
determining, using the entry, whether the artifact image identified in the request is different from the version of the artifact image previously deployed;
determining, using the entry, whether the computing environment identified in the request has changed since the previous deployment; and
deploying the artifact image to the computing environment only upon determining that at least one of (i) the artifact image is different from the version of the artifact image previously deployed, or (ii) the computing environment identified in the request has changed since the previous deployment.

2. The computer-implemented method of claim 1, wherein identifying the entry comprises:
generating an image hash value based on a first identifier for the artifact image;
generating an environment hash value based on a second identifier for the computing environment; and
identifying the entry based on matching the image has value and the environment hash value with corresponding values in the entry.

3. The computer-implemented method of claim 1, wherein the historical data is stored in a cache.

4. The computer-implemented method of claim 1, wherein determining whether the artifact image identified in the request is different from the version of the artifact image previously deployed comprises:
generating a current checksum for the artifact image to be deployed;
determining, from the entry, a checksum generated for the version of the artifact image previously deployed; and
comparing the current checksum to the checksum generated for the version of the artifact image previously deployed to determine whether the artifact image identified in the request is different from the version of the artifact image previously deployed.

5. The computer-implemented method of claim 1, wherein determining whether the computing environment identified in the request has changed since the previous deployment comprises:
determining metadata for the computing environment at a time associated with the previous deployment;
accessing current metadata for the computing environment; and
comparing the current metadata with the metadata for the computing environment at the time associated with the previous deployment to determine whether the computing environment identified in the request has changed since the previous deployment.

6. The computer-implemented method of claim 5, wherein comparing the current metadata with the metadata for the computing environment at the time associated with the previous deployment comprises:
determining a type of instance of the computing environment;
determining a plurality of fields of metadata associated with the type of instance; and
comparing the plurality of fields of the current metadata with the plurality of fields of the metadata for the computing environment at the time associated with the previous deployment to determine whether the computing environment identified in the request has changed since the previous deployment.

7. The computer-implemented method of claim 1, wherein the computing environment has a type of instance, and wherein the type of instance is one of a compute instance, a container instance, a Kubernetes cluster, or a function.

8. The computer-implemented method of claim 7, wherein the compute instance has a first set of metadata that includes (i) operating system updates and patches, (ii) CPU and memory resources, (iii) routing tables, (iv) security groups, (v) IP addressing, and (vi) firewall settings.

9. The computer-implemented method of claim 8, wherein the container instance has a second set of metadata that includes (i) container network interface, (ii) resource quotas, (iii) storage volumes, and (iv) namespace isolation.

10. The computer-implemented method of claim 9, wherein the Kubernetes cluster has a third set of metadata that includes (i) a Kubernetes cluster version and (ii) node resources.

11. The computer-implemented method of claim 10, wherein the function has a fourth set of metadata that includes (i) trigger configuration, (ii) memory limits, (iii) timeout settings, and (iv) virtual private cloud integration.

12. The computer-implemented method of claim 1, wherein deploying the artifact image to the computing environment only upon determining that at least one of (i) the artifact image is different from the version of the artifact image previously deployed, or (ii) the computing environment identified in the request has changed since the previous deployment further comprises not deploying the artifact image to the computing environment based on determining that (i) and (ii) are both false.

13. The computer-implemented method of claim 12, further comprising presenting user-selectable option via a graphical user interface, wherein receiving selection of the option causes the artifact image to be deployed to the computing environment regardless of whether (i) and (ii) are false.

14. The computer-implemented method of claim 1, wherein the entry is a cache entry stored in a cache, and wherein the entry comprises an environment identification, a stage identification, an image identification, an image checksum, a type of environment, specifics of the environment, and a timestamp.

15. A system comprising:
one or more processors; and
a memory coupled to the one or more processors, the memory storing a plurality of instructions executable by the one or more processors, the plurality of instructions comprising instructions executable by the one or more processors to cause the one or more processors to perform operations comprising:
receiving a request to deploy an artifact image to a computing environment;
accessing historical deployment data comprising information related to one or more deployments performed prior to the receiving;
identifying, in the historical deployment data, an entry corresponding to a previous deployment of a version of the artifact image to the computing environment;
determining, using the entry, whether the artifact image identified in the request is different from the version of the artifact image previously deployed;
determining, using the entry, whether the computing environment identified in the request has changed since the previous deployment; and
deploying the artifact image to the computing environment only upon determining that at least one of (i) the artifact image is different from the version of the artifact image previously deployed, or (ii) the computing environment identified in the request has changed since the previous deployment.

16. The system of claim 15, wherein the historical data is stored in a cache, and wherein the operation of identifying the entry comprises:
generating an image hash value based on a first identifier for the artifact image;
generating an environment hash value based on a second identifier for the computing environment; and
identifying the entry based on matching the image has value and the environment hash value with corresponding values in the entry.

17. The system of claim 15, wherein the operation of determining whether the artifact image identified in the request is different from the version of the artifact image previously deployed comprises:
generating a current checksum for the artifact image to be deployed;
determining, from the entry, a checksum generated for the version of the artifact image previously deployed; and
comparing the current checksum to the checksum generated for the version of the artifact image previously deployed to determine whether the artifact image identified in the request is different from the version of the artifact image previously deployed.

18. The system of claim 15, wherein the operation of determining whether the computing environment identified in the request has changed since the previous deployment comprises:
determining metadata for the computing environment at a time associated with the previous deployment;
accessing current metadata for the computing environment; and
comparing the current metadata with the metadata for the computing environment at the time associated with the previous deployment to determine whether the computing environment identified in the request has changed since the previous deployment.

19. A non-transitory computer-readable memory storing a plurality of instructions executable by one or more processors, the plurality of instructions comprising instructions that when executed by the one or more processors cause the one or more processors to perform operations, comprising:
receiving a request to deploy an artifact image to a computing environment;
accessing historical deployment data comprising information related to one or more deployments performed prior to the receiving;
identifying, in the historical deployment data, an entry corresponding to a previous deployment of a version of the artifact image to the computing environment;
determining, using the entry, whether the artifact image identified in the request is different from the version of the artifact image previously deployed;
determining, using the entry, whether the computing environment identified in the request has changed since the previous deployment; and
deploying the artifact image to the computing environment only upon determining that at least one of (i) the artifact image is different from the version of the artifact image previously deployed, or (ii) the computing environment identified in the request has changed since the previous deployment.

20. The non-transitory computer-readable memory of claim 19, wherein the computing environment has a type of instance, wherein the type of instance is one of a compute instance, a container instance, a Kubernetes cluster, or a function, wherein the compute instance has a first set of metadata that includes (i) operating system updates and patches, (ii) CPU and memory resources, (iii) routing tables, (iv) security groups, (v) IP addressing, and (vi) firewall settings, wherein the container instance has a second set of metadata that includes (i) container network interface, (ii) resource quotas, (iii) storage volumes, and (iv) namespace isolation, wherein the Kubernetes cluster has a third set of metadata that includes (i) a Kubernetes cluster version and (ii) node resources, and wherein the function has a fourth set of metadata that includes (i) trigger configuration, (ii) memory limits, (iii) timeout settings, and (iv) virtual private cloud integration.
